(19) United States
(12) Patent Application Publication
(10) Pub. No.: US 2025/0317680 A1
(43) Pub. Date: Oct. 9, 2025

(54) Earphone device, operation method and charging box thereof

(71) Applicant: Acrox Technologies Co., Ltd., Taipei City (TW)

(72) Inventor: Hao-Chieh Chen, Taipei City (TW)

(21) Appl. No.: 18/974,175

(22) Filed: Dec. 9, 2024

(30) Foreign Application Priority Data
Jan. 12, 2024 (TW) 113101437

(51) Int. Cl. H04R 1/10; H04R 1/02

(52) U.S. Cl. CPC H04R 1/1025; H04R 1/02; H04R 2420/07

(57) ABSTRACT

The present invention provides an earphone device, an operation method and a charging box thereof. The earphone device includes a charging box and a pair of Bluetooth earphones. The charging box includes a first wireless transceiver and a microcontroller unit (MCU). The first wireless transceiver is configured to transceive a first wireless signal. The pair of Bluetooth earphones is detachably disposed in the charging box and electrically connected to the charging box and configured to receive a Bluetooth wireless signal or the first wireless signal. The microcontroller unit (MCU) is configured in the charging box to provide a control signal to manage a connection or charging of the Bluetooth earphones.

### CROSS-REFERENCE TO RELATED APPLICATION AND CLAIM OF PRIORITY

The application claims the benefit of Taiwan Patent Application No. 113101437, filed on Jan. 12, 2024, at the Taiwan Intellectual Property Office, the disclosures of which are incorporated herein in their entirety by reference.

### FIELD OF THE INVENTION

The present invention generally relates to an earphone device, an operation method and a charging box thereof and, more particularly, to a multi-mode earphone device, an operation method and a charging box thereof.

### BACKGROUND OF THE INVENTION

In recent years, Bluetooth earphone devices have become widely popular in the market due to their advantages of being unbound by earphone wires, and allowing distant listening. However, Bluetooth earphone devices suffer from a flaw where the audio is relatively delayed compared to the video. Among existing Bluetooth earphone devices, even an Apple's AirPods has a latency rate being up to 200 milliseconds. While this latency rate might be imperceptible when listening to music, it becomes problematic when watching videos, playing video games, or video calls with accompanying audio, as it causes audio-video sync issues, leading to a poor user experience. The recently released “realme Buds” series, despite developing a gaming mode to reduce delay, only manage to lower the latency rate to 120 milliseconds, which is still far from the 10 milliseconds latency rate of wired earphones. Therefore, developing Bluetooth earphone devices with low latency is currently one of the main goals of wireless Bluetooth technology.

In addition, the charging boxes of conventional Bluetooth earphone devices serve no other function than storing and charging the Bluetooth earphones. If the space within the charging box can be utilized to incorporate additional components to improve the functions of existing Bluetooth earphone devices, the high latency issue and even more defects of current devices can be potentially solved.

Accordingly, the present invention is conceived by combining other wireless technologies and integrating additional wireless transceivers into the charging box to overcome the shortcomings in the prior art. The following is a brief description of the present invention.

### SUMMARY OF THE INVENTION

In view of the above, one object of the present invention is to provide an earphone device, an operation method and a charging box thereof to reduce the latency rate of an electronic device during gaming and video playback, so that audio and video synchronization issues or other existing drawbacks of Bluetooth earphone devices can be avoided.

In order to achieve the foregoing object, the present invention provides an earphone device. The earphone device includes a charging box and a pair of Bluetooth earphones. The charging box includes a first wireless transceiver and a microcontroller unit (MCU). The first wireless transceiver is configured to transceive a first wireless signal. The pair of Bluetooth earphones is detachably disposed in the charging box and electrically connected to the charging box and configured to receive a Bluetooth wireless signal or the first wireless signal. The microcontroller unit (MCU) is configured in the charging box to provide a control signal to manage a connection or charging of the Bluetooth earphones.

The present invention further provides an operation method of an earphone device. The earphone device includes a charging box and a pair of Bluetooth earphones, and is electrically connected to an electronic device. The operation method includes the following steps. First, a first audio transmitted by the first electronic device is received by the charging box. Then, a first wireless signal corresponding to the first audio is transmitted to the pair of Bluetooth earphones to play the first audio.

The present invention further provides a charging box for use with a pair of Bluetooth earphones. The charging box includes a first wireless transceiver, and a microcontroller unit (MCU). The first wireless transceiver is configured to transceive a first wireless signal. The microcontroller unit (MCU) is disposed in the charging box and configured to provide a control signal to manage a connection or charging of the pair of Bluetooth earphones.

Therefore, the present invention provides various earphone devices, operation methods, and charging boxes thereof, solving the core issue of existing Bluetooth earphone devices such as impossibility for gaming and audio-video synchronization problems, along with other defects.

### BRIEF DESCRIPTION OF THE DRAWINGS

The above embodiments and advantages of the present invention will become more readily apparent to those ordinarily skilled in the art after reviewing the following detailed descriptions and accompanying drawings.

FIG. 1 is a schematic diagram of an earphone device according to a first preferred embodiment of the present invention;

FIG. 2 is a schematic diagram of an earphone device according to a second preferred embodiment of the present invention;

FIG. 3 is a schematic diagram of the earphone device according to a third preferred embodiment of the present invention;

FIG. 4 is a schematic diagram of the earphone device according to a fourth preferred embodiment of the present invention;

FIG. 5 is a schematic diagram of the earphone device according to a fifth preferred embodiment of the present invention;

FIG. 6 is a schematic diagram of the earphone device according to a sixth preferred embodiment of the present invention; and

FIG. 7 is a schematic diagram of the earphone device according to a seventh preferred embodiment of the present invention.

### DETAILED DESCRIPTION OF THE PREFERRED EMBODIMENTS

Please refer to all figures of the present invention when reading the following detailed description, wherein all figures of the present invention demonstrate different embodiments of the present invention by showing examples, and help the skilled person in the art to understand how to implement the present invention. The present examples provide sufficient embodiments to demonstrate the spirit of the present invention, each embodiment does not conflict with the others, and new embodiments can be implemented through an arbitrary combination thereof, i.e., the present invention is not restricted to the embodiments disclosed in the present specification. Unless there are other restrictions defined in the specific example, the following definitions apply to the terms used throughout the specification.

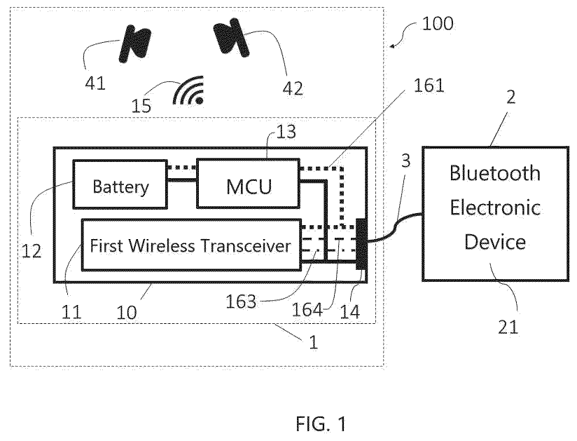

Referring to FIG. 1 to FIG. 4, the earphone device 100 of the present invention includes: a charging box 1 and a pair of Bluetooth earphones 41, 42, which can be placed inside the charging box 1. The charging box 1 includes a case 10 and a lid (not shown) that snaps onto the case 10. Inside the case 10 of the charging box 1, there are provided a wireless transceiver 11, a battery 12, a microcontroller unit (MCU) 13, and a circuit device 16. The circuit device 16 includes a power cable 161, a ground wire 162, and differential signal lines 163, 164. The charging box 1 includes a connection port 14, which can be connected to an electronic device or a power source 6 through a transmission cable 3 to transmit signals or power to the charging box 1. The wireless transceiver 11 transmits signals through the differential signal lines 163, 164. In one embodiment, the microcontroller unit (MCU) 13 is configured to provide a control signal to control the connection or charging of Bluetooth earphones 41, 42. In one embodiment, the control signal can be a universal asynchronous receiver/transmitter (UART) control signal. In another embodiment, the control signal can be a Bluetooth control signal. More particularly, the battery 12 and the microcontroller unit 13 can be electrically connected to the wireless transceiver 11 through the power cable 161. The electronic device can selectively be a Bluetooth electronic device 2 or a non-Bluetooth electronic device 5, though the implementation differs between the two. More particularly, the electronic device can be a computer, a smart phone, a tablet, a gaming console, etc. The implementation methods for connecting the earphone device 100 to the Bluetooth electronic device 2, the non-Bluetooth electronic device 5, and the power source 6 are described below.

Please refer to FIG. 1, which is a schematic diagram of an earphone device according to a first preferred embodiment of the present invention. In FIG. 1, the charging box 1 is connected to the Bluetooth electronic device 2 through a transmission cable 3. The power from the Bluetooth electronic device 2 is transmitted to the charging box 1 through the transmission cable 3, and then sequentially transmitted to the microcontroller unit 13 and battery 12 through the power cable 161 to charge the battery 12. Moreover, when the Bluetooth electronic device 2 plays a first audio 21, the first audio 21 is transmitted to the charging box 1 through the transmission cable 3, and then transmitted to the wireless transceiver 11 through differential signal lines 163, 164 so as to trigger the wireless transceiver 11 inside the charging box 1 to transmit a wireless signal 15. The wireless signal 15 is further transmitted to the pair of Bluetooth earphones 41, 42, enabling them to connect with the Bluetooth electronic device 2 and play the first audio 21. The connection between the Bluetooth electronic device 2 and the Bluetooth earphone 41, 42 through the wireless signal 15 can reduce the latency rate of the first audio 21 to less than 40 milliseconds, achieving a low latency of the same order of magnitude as the latency rate (10 milliseconds) of a wired earphone device. Audio and video playback through the wireless signal 15 can avoid the audio-video synchronization issues inherent in conventional earphone devices.

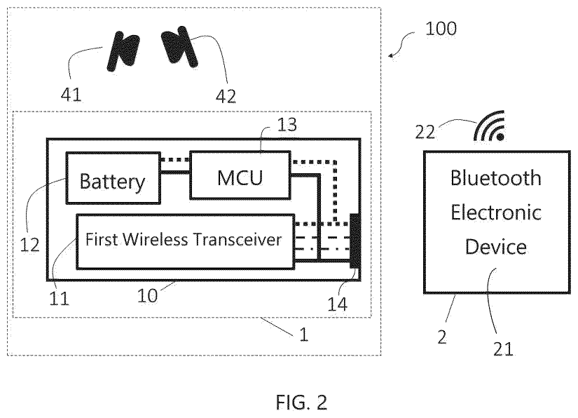

Please refer to FIG. 2, which is a schematic diagram of an earphone device according to a second preferred embodiment of the present invention. In FIG. 2, the Bluetooth electronic device 2 is not connected to the charging box 1 through a transmission cable 3. When the Bluetooth electronic device 2 plays the first audio 21, it triggers the Bluetooth electronic device 2 to transmit a first Bluetooth wireless signal 22, which is further transmitted to the pair of Bluetooth earphones 41, 42, enabling them to connect with the Bluetooth electronic device 2 and play the first audio 21. This avoids the inconvenience of needing to carry a transceiver with conventional wireless earphones.

According to all of the above embodiments, when the user engages in activities involving both video and audio, such as playing games, watching videos, or video calling, the Bluetooth electronic device 2 is connected to the charging box 1 through the transmission cable 3. The wireless signal 15 connects the Bluetooth electronic device 2 with the pair of Bluetooth earphones 41, 42 to avoid audio-video synchronization issues. Meanwhile, the Bluetooth electronic device 2 charges the charging box 1, allowing the user to play games while charging and saving time waiting for charging. When the user engages in pure audio activities such as listening to music or voice calls, the Bluetooth electronic device 2 does not need to be connected to the charging box 1 through the transmission cable 3. Instead, the Bluetooth electronic device 2 connects through the first Bluetooth wireless signal 22 to the pair of Bluetooth earphones 41, 42.

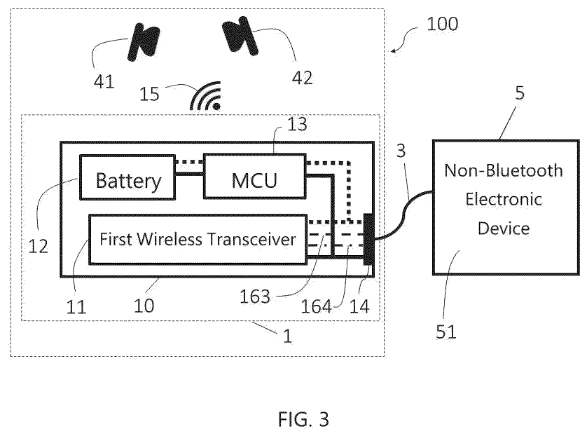

Please refer to FIG. 3, which is a schematic diagram of the earphone device according to a third preferred embodiment of the present invention. In FIG. 3, the charging box 1 of the earphone device 100 is connected to a non-Bluetooth electronic device 5 through a transmission cable 3. When the non-Bluetooth electronic device 5 plays a first audio 51, the first audio 51 is transmitted to the charging box 1 through the transmission cable 3. The first audio 51 is then transmitted to the wireless transceiver 11 through differential signal lines 163, 164 so as to trigger the wireless transceiver 11 inside the charging box 1 to transmit a wireless signal 15. The wireless signal 15 is further transmitted to the pair of Bluetooth earphones 41, 42, enabling them to connect with the non-Bluetooth electronic device 5 and play the first audio 51.

The earphone device 100 of the present invention can connect the pair of Bluetooth earphones 41, 42 with the non-Bluetooth electronic device 5 through the wireless signal 15. In other words, the earphone device 100 of the present invention can also be used as a regular wireless earphone device with non-Bluetooth electronic devices 5.

According to all the above embodiments, the pair of Bluetooth earphones 41, 42 of the earphone device 100 of the present invention can receive an audio played by an electronic device with the following steps. First, the electronic device transmits an audio through a transmission cable to the charging box that further transmits a first Bluetooth wireless signal corresponding to the audio to the pair of Bluetooth earphones 41, 42. The pair of Bluetooth earphones 41, 42 receives the first wireless signal to play the audio. Second, when the audio played by the electronic device cannot be transmitted to the charging box 1 through a transmission cable, the electronic device transmits a first Bluetooth wireless signal corresponding to the audio to the pair of Bluetooth earphones 41, 42. The pair of Bluetooth earphones 41, 42 receives the first Bluetooth wireless signal to play the audio.

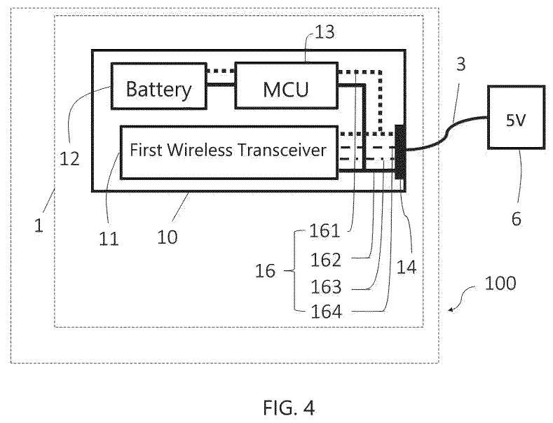

Please refer to FIG. 4, which is a schematic diagram of the earphone device according to a fourth preferred embodiment of the present invention. In FIG. 4, the Bluetooth earphones (not shown) are placed inside the charging box 1, which is connected to a power source 6 through a transmission cable 3. The power source 6 delivers power through the transmission cable 3, the connection port 14, the power cable 161, the microcontroller unit 13 to the battery 12 that further charges the pair of Bluetooth earphones placed inside the charging box 1.

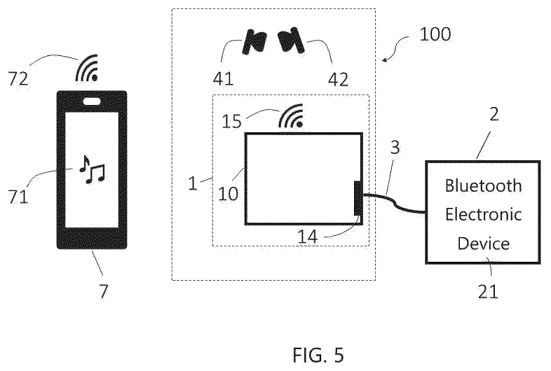

The earphone device 100 of the present invention can prioritize the most suitable way of connection with one of at least two electronic devices. The implementations are described in the following embodiments. Please refer to FIG. 5, which is a schematic diagram of the earphone device according to a fifth preferred embodiment of the present invention. In FIG. 5, the charging box 1 is connected to the Bluetooth electronic device 2 through the transmission cable 3, and the pair of Bluetooth earphones 41, 42 is coupled to a mobile device 7 through Bluetooth communication. When the Bluetooth electronic device 2 plays a first audio 21, and the mobile device 7 plays a second audio 71, the first audio 21 is transmitted to the charging box 1 through the transmission cable 3, which triggers the charging box 1 to transmit a wireless signal 15. The second audio 71 triggers the mobile device 7 to transmit a second Bluetooth wireless signal 72, and the pair of Bluetooth earphones 41, 42 will preferentially receive the second Bluetooth wireless signal 72. In other words, when using the Bluetooth electronic device 2 (for example, a laptop computer) for audio-visual activities such as gaming, the Bluetooth electronic device 2 is connected to the charging box 1 through the transmission cable 3 to avoid audio-video synchronization issues. Meanwhile, if the mobile device 7 (for example, a smart phone) rings and the user chooses to answer the call, the earphone device 100 of the present invention will automatically switch to receive the phone signal from the mobile device 7. After the call is finished and hung up, the second Bluetooth wireless signal 72 disappears, and the earphone device 100 receives the wireless signal 15 to play the first audio 21. The Bluetooth electronic device in this embodiment can also be replaced with a non-Bluetooth electronic device (for example, a desktop computer).

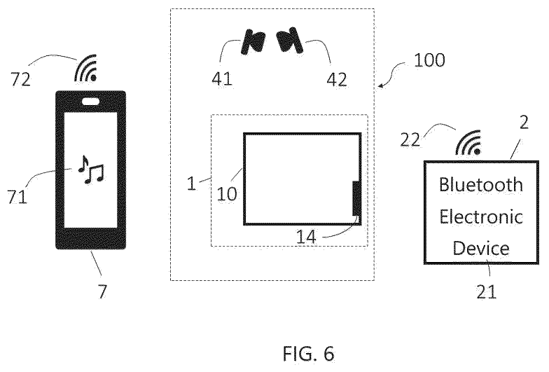

Please refer to FIG. 6, which is a schematic diagram of the earphone device according to a sixth preferred embodiment of the present invention. In FIG. 6, the charging box 1 is not connected to the Bluetooth electronic device 2 through the transmission cable 3, and instead, the pair of Bluetooth earphones 41, 42 is coupled to the Bluetooth electronic device 2 and the mobile device 7 through Bluetooth communication. When the Bluetooth electronic device 2 plays the first audio 21 and the mobile device 7 plays the second audio 71, the first audio 21 triggers the Bluetooth electronic device 2 to transmit the first Bluetooth wireless signal 22 and the second audio 71 triggers the mobile device 7 to transmit the second Bluetooth wireless signal 72. When the strength of the first Bluetooth wireless signal 22 is greater than the second Bluetooth wireless signal 72, the pair of Bluetooth earphones 41, 42 chooses to receive the first Bluetooth wireless signal 22 to play the first audio 21. Conversely, when the strength of the first Bluetooth wireless signal 22 is less than the second Bluetooth wireless signal 72, the pair of Bluetooth earphones 41, 42 chooses to receive the second Bluetooth wireless signal 72 to play the second audio 71.

According to all of the above embodiments, when the first electronic device and the second electronic device play audios simultaneously, where the first electronic device plays the first audio and the second electronic device plays the second audio, the pair of Bluetooth earphones 41, 42 of the earphone device 100 of the present invention can receive the played audios with the following steps. First, when the second electronic device transmits a second Bluetooth wireless signal corresponding to the second audio, and the charging box transmits a first wireless signal corresponding to the first audio simultaneously, the pair of Bluetooth earphones 41, 42 will preferentially receive the second Bluetooth wireless signal to play the second audio. Second, when the first electronic device transmits a first Bluetooth wireless signal corresponding to the first audio and the second electronic device transmits a second Bluetooth wireless signal corresponding to the second audio simultaneously, the pair of Bluetooth earphones 41, 42 will preferentially receive the first Bluetooth wireless signal to play the first audio if the strength of the first Bluetooth wireless signal is greater than the second Bluetooth wireless signal. Third, when the first electronic device transmits a first Bluetooth wireless signal corresponding to the first audio, and the second electronic device transmits a second Bluetooth wireless signal corresponding to the second audio simultaneously, the pair of Bluetooth earphones 41, 42 will preferentially receive the second Bluetooth wireless signal to play the second audio if the strength of the first Bluetooth wireless signal is less than the second Bluetooth wireless signal.

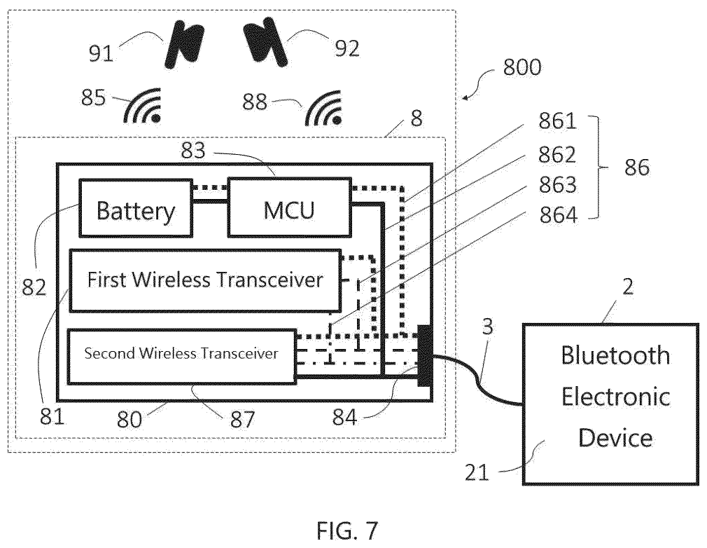

In another embodiment, the earphone device of the present invention can have at least two wireless transceivers, allowing the Bluetooth earphones to choose the most suitable way of connection with the electronic device based on the usage state. The implementations are described as follows. Please refer to FIG. 7, which is a schematic diagram of the earphone device according to a seventh preferred embodiment of the present invention. The earphone device 800 of the present invention includes a charging box 8 and a pair of Bluetooth earphones 91, 92. Inside the case 80 of the charging box 8, in addition to a first wireless transceiver 81, there is also a second wireless transceiver 87. The second wireless transceiver 87 is electrically connected to the first wireless transceiver 81, a battery 82, a microcontroller unit (MCU) 83, and a connection port 84 through a circuit device 86. The circuit device 86 includes a power cable 861, a ground wire 862, and differential signal lines 863, 864. Signals are transmitted through the differential signal lines 863, 864. The charging box 8 may also include a lid (not shown) that snaps onto the case 80. In one embodiment, the microcontroller unit (MCU) 83 is configured to provide a control signal to control the connection or charging of a pair of Bluetooth earphones 91. 92. In one embodiment, the control signal can be a universal asynchronous receiver/transmitter (UART) control signal. In another embodiment, the control signal can be a Bluetooth control signal.

In FIG. 7, the connection port 84 of the charging box 8 is connected to the Bluetooth electronic device 2 through the transmission cable 3. When the Bluetooth electronic device 2 plays the first audio 21, the pair of Bluetooth earphones 91, 92 communicates with the Bluetooth electronic device 2 through the wireless signal 85 transmitted by the first wireless transceiver 81 if the distance between the pair of Bluetooth earphones 91, 92 of the earphone device 800 and the Bluetooth electronic device 2 is less than 10 meters. If the distance between the pair of Bluetooth earphones 91, 92 of the earphone device 800 and the Bluetooth electronic device 2 is greater than 10 meters, the pair of Bluetooth earphones 91, 92 can communicate with the Bluetooth electronic device 2 through the second wireless signal 88 (for example, a Kleer wireless signal) transmitted by the second wireless transceiver 87 (for example, a Kleer wireless transceiver). Generally speaking, a 2.4-GHz wireless signal has a disadvantage of not being able to transmit over long distances, whereas a Kleer signal can currently transmit up to 100 meters. Therefore, this embodiment utilizes the characteristics of the second wireless signal 88, which can transmit over long distances, to prevent the earphone device 800 from losing signal when the distance between the pair of Bluetooth earphones 91, 92 and the Bluetooth electronic device 2 is greater. The Bluetooth electronic device in this embodiment can also be replaced with a non-Bluetooth electronic device. Additionally, similar to the previously mentioned earphone device 100, the connection port 84 of the charging box 8 may be connected to the Bluetooth electronic device 2 without the transmission cable 3. The pair of Bluetooth earphones 91, 92 can be used independently to receive the audio through the Bluetooth wireless signal.

According to all of the above embodiments, the earphone device 800 of the present invention can include a plurality of wireless transceivers. In this case, the pair of Bluetooth earphones 91, 92 can receive the audio 21 played by the Bluetooth electronic device 2 with the following steps. First, the Bluetooth electronic device 2 transmits the audio 21 through a transmission cable 3 to the charging box 8 that further transmits a first wireless signal and/or a second wireless signal corresponding to the audio 21. The first wireless signal and/or the second wireless signal are transmitted to the pair of Bluetooth earphones 91, 92 that preferentially receives the first wireless signal to play the audio 21. Second, when the pair of Bluetooth earphones 91, 92 cannot receive the first wireless signal, the pair of Bluetooth earphones 91, 92 receives the second wireless signal to play the audio 21. Third, when the audio 21 played by the Bluetooth electronic device 2 cannot be transmitted to the charging box 8, the Bluetooth electronic device 2 transmits a Bluetooth wireless signal corresponding to the audio 21, and the pair of Bluetooth earphones 91, 92 receives the Bluetooth wireless signal to play the audio 21.

In addition to the aforementioned second wireless transceiver, those skilled in the art can also select other wireless transceivers with different communication protocols to be integrated into the charging box as a second wireless transceiver, or to install three or more wireless transceivers with different communication protocols in the charging box. The wireless transceivers in the charging box can be any combination, not limited to the embodiments mentioned above. However, any combination of wireless transceivers in the charging box is based on the spirit of the present invention and falls within the scope as disclosed in the present invention.

The internal circuit devices in the charging boxes in all the above embodiments are only described for convenience in explaining the internal power and signal transmission way of the earphone device disclosed in the present invention and should not be understood as a limitation of the present invention.

The wireless transceivers in all the above embodiments can be replaced with 2.4-GHz, 5-GHz, or other band wireless transceivers (not shown), so the wireless signals transmitted by the charging box are not limited to using 2.4-GHz, 5-GHz, or other band wireless signals.

In summary, the present invention can indeed solve the long-standing problem of high latency in the prior art Bluetooth earphone devices by installing wireless transceivers in the charging box. Furthermore, by installing various combinations of wireless transceivers in the charging box, it can solve other shortcomings of traditional Bluetooth earphone devices or expand new functions.

While the disclosure has been described in terms of what is presently considered to be the most practical and preferred embodiments, it is to be understood that the disclosure need not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. An earphone device, comprising:
a charging box, comprising:
a first wireless transceiver, configured to transceive a first wireless signal; and
a microcontroller unit (MCU), disposed in the charging box; and
a pair of Bluetooth earphones, detachably accommodated in the charging box and configured to receive a Bluetooth wireless signal or the first wireless signal,
wherein the microcontroller unit is configured to provide a control signal to manage a connection or charging of the pair of Bluetooth earphones.

2. The earphone device of claim 1, wherein the first wireless transceiver is configured to reduce a latency rate of an audio received by the pair of Bluetooth earphones.

3. The earphone device of claim 1, wherein the charging box further comprises a battery configured to charge the pair of Bluetooth earphones.

4. The earphone device of claim 1, wherein the charging box further comprises a second wireless transceiver configured to transceive a second wireless signal with a communication protocol different from that of the first wireless signal.

5. The earphone device of claim 4, wherein the second wireless transceiver transceives the second wireless signal corresponding to the audio when the circuit device transmits the audio to the second wireless transceiver, and the microcontroller unit controls the pair of Bluetooth earphones to selectively receive either the first wireless signal or the second wireless signal transmitted by the charging box.

6. The earphone device of claim 1, wherein the control signal is a universal asynchronous receiver/transmitter (UART) control signal.

7. The earphone device of claim 1, wherein the control signal is a Bluetooth control signal.

8. A charging box for use with a pair of Bluetooth earphones, comprising:
a first wireless transceiver, configured to transceive a first wireless signal; and
a microcontroller unit (MCU), disposed in the charging box and configured to provide a control signal to manage a connection or charging of the pair of Bluetooth earphones.

9. The charging box of claim 8, further comprising:
a case configured to detachably accommodate the pair of Bluetooth earphones;
a battery disposed in the case and configured to charge the pair of Bluetooth earphones; and
a circuit device disposed in the case, electrically connected to the battery and the first wireless transceiver and configured to transmit an audio to the first wireless transceiver such that the first wireless transceiver transceives a first wireless signal corresponding to the audio.

10. The charging box of claim 9, further comprising a second wireless transceiver electrically connected to the circuit device and configured to transceive a second wireless signal with a communication protocol different from that of the first wireless signal.

11. The charging box of claim 10, wherein the second wireless transceiver transceives the second wireless signal corresponding to the audio when the circuit device transmits the audio to the second wireless transceiver, and the microcontroller unit controls the pair of Bluetooth earphones to selectively receive either the first wireless signal or the second wireless signal transmitted by the charging box.

12. The charging box of claim 8, wherein the first wireless transceiver is configured to reduce a latency rate of the audio received by the pair of Bluetooth earphones.

13. The charging box of claim 9, wherein the control signal is a universal asynchronous receiver/transmitter (UART) control signal.

14. The charging box of claim 9, wherein the control signal is a Bluetooth control signal.

15. An operation method of an earphone device, wherein the earphone device comprising a charging box and a pair of Bluetooth earphones is electrically connected to a first electronic device, the operation method comprising:
receiving a first audio transmitted by the first electronic device; and
transmitting a first wireless signal corresponding to the first audio to the pair of Bluetooth earphones to play the first audio.

16. The operation method of claim 15, further comprising:
receiving by the pair of Bluetooth earphones a first Bluetooth wireless signal corresponding to the first audio from the first electronic device when the first audio played by the first electronic device fails to be transmitted to the charging box.

17. The operation method of claim 15, wherein the earphone device is further electrically connected to a second electronic device, the operation method further comprising:
preferentially receiving a second Bluetooth wireless signal from the second electronic device by the pair of Bluetooth earphones to play the second audio.

18. The operation method of claim 17, further comprising:
receiving by the pair of Bluetooth earphones the first Bluetooth wireless signal corresponding to the first audio from the first electronic device when the first audio played by the first electronic device fails to be transmitted to the charging box.

19. The operation method of claim 15, further comprising:
transmitting a second wireless signal corresponding to the first audio to the pair of Bluetooth earphones; and
preferentially receiving the first wireless signal by the pair of Bluetooth earphones to play the audio.

20. The operation method of claim 19, further comprising:
receiving the second wireless signal to play the audio when the pair of Bluetooth earphones fails to receive the first wireless signal; and
transmitting by the first electronic device a Bluetooth wireless signal corresponding to the audio to the pair of Bluetooth earphones to play the audio when the audio played by the first electronic device fails to be transmitted to the charging box.
